(19) United States
(12) Patent Application Publication
(10) Pub. No.: US 2026/0078809 A1
(43) Pub. Date: Mar. 19, 2026

(54) BRAKE MECHANISM

(71) Applicant: Helen of Troy Limited, St. Michael (BB)

(72) Inventors: Conor McNamara, Montclair, NJ (US); Dio Climaco Cavero, North Merrick, NY (US); Adam Sebastian Sanchez, Wantage, NJ (US); Shaun Zirges, Jersey City, NJ (US); Marcus Z. Williams, West Orange, NJ (US)

(21) Appl. No.: 18/886,162

(22) Filed: Sep. 16, 2024

(51) Int. Cl. F16D 65/00; F16D 65/02

(52) U.S. Cl. CPC F16D 65/0056; F16D 2065/1384; F16D 2065/1392

(57) ABSTRACT

A support for an appliance includes a base rotatably supporting a wheel, and a braking mechanism secured by the base. The braking mechanism includes a brake member in selective engagement with the wheel, an operating member, and a flexible connector connecting the brake member to the operating member. The operating member is movable from a first position where the brake member is engaged with the wheel to a second position where the brake member is disengaged from the wheel. The connector moves both in a first direction and a second direction transverse to the first direction as the operating member is moved between the first position and the second position.

### BACKGROUND

As more and more small appliances are available to the consumer kitchen space has become a challenge. Many such appliances have become a part of the everyday routine, and the placement of the appliance on a work surface, such a countertop, to provide ease of access is important. Due to the finite amount of countertop space, it is generally desirable to minimize the amount of space used by the appliance.

In addition, the placement of an appliance on a countertop can cause problems with the use of the appliance. For example, due to the depth and/or height of the countertop, the appliance may be located a distance from a user that renders operation inconvenient or difficult. Further, in most kitchens much of the countertop is positioned below wall-mounted storage cabinets. Certain appliances may be of such a construction that they cannot be operated when positioned underneath the storage cabinets. For example, water reservoirs of traditional drip-style coffee makers are typically filled through an opening in the top of the coffee maker, which typically requires sufficient clearance for the user to add water into the reservoir. A user must then drag the appliance out from under the wall-mounted cabinets to prepare the machine for operation.

### SUMMARY

According to one aspect, a support for an appliance comprises a base rotatably supporting a wheel, and a braking mechanism secured by the base. The braking mechanism includes a brake member in selective engagement with the wheel, an operating member, and a flexible connector connecting the brake member to the operating member. The operating member is movable from a first position where the brake member is engaged with the wheel to a second position where the brake member is disengaged from the wheel. The connector moves both in a first direction and a second direction transverse to the first direction as the operating member is moved between the first position and the second position.

According to another aspect, a braking mechanism for a wheeled support for an appliance is provided. The brake mechanism comprises an operating member having a first part movable in a first direction. First and second brake members are movable in a second direction between an engaged state for braking respective first and second wheels of the support and a disengaged state. The second direction is transverse to the first direction. First and second flexible connectors connect the operating member to the respective first and second brake members. Movement of the first part of the operating member in the first direction moves the first and second brake members in the second direction between the engaged state and a disengaged state.

### BRIEF DESCRIPTION OF THE DRAWINGS

FIG. 1 is a perspective view of a support for an appliance according to the present disclosure.

FIG. 2 is a partial exploded perspective of FIG. 1.

FIG. 3 is a bottom perspective view of FIG. 1.

FIG. 4 is a perspective view of a braking mechanism of the support of FIG. 1.

FIG. 5 is a perspective view of the braking mechanism.

FIG. 6 is a partial exploded perspective of the braking mechanism.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Further, any term of degree used herein, such as “substantially”, means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

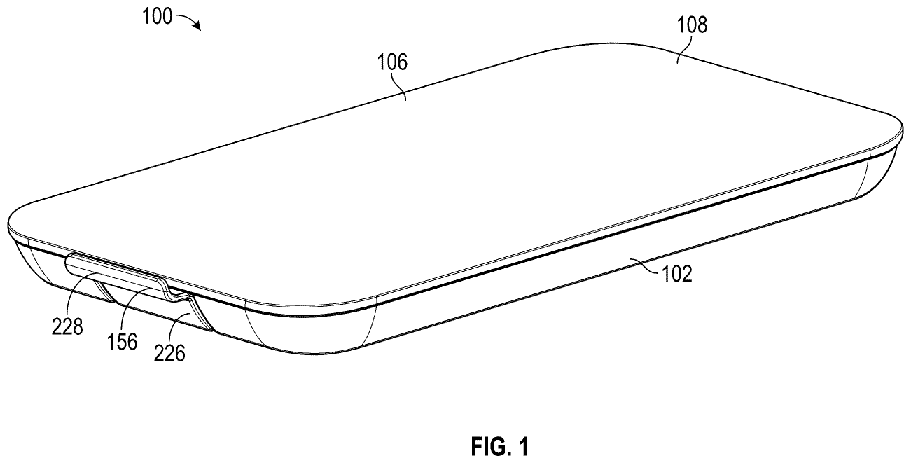

Referring now to the drawings, wherein like numerals refer to like parts throughout the several views, FIGS. 1-3 illustrate a rolling support 100 for an appliance. Examples of appliances that may be used in conjunction with the support 100 include blenders, coffee makers, steamers, air fryers and toasters. The support 100 comprises a base 102 and a braking mechanism 104 secured by the base. The base 102 is one of separate from the appliance and provided as part of the appliance. Specifically, as depicted, the base 102 can be provided as part of a stand-alone support, where a cover 106 is mounted to the base. The cover 106 can include a rubberized or textured exterior surface 108 so that an appliance can be securely placed atop the support. Therefore, with the exterior surface 108 the cover 106 supports the appliance with a high degree of stability minimizing the potential of the appliance falling after being placed on support 100. While it is illustrated that the stand alone support 100 has a generally rectangular shape, it is possible for the support to be formed with alternative shapes, examples of which include square, round and oval. As indicated, the base 102 can be provided as part of an appliance. For example, the support 100 can integrally form part of a lower housing for the appliance, and with this arrangement, the cover 106 would not be required.

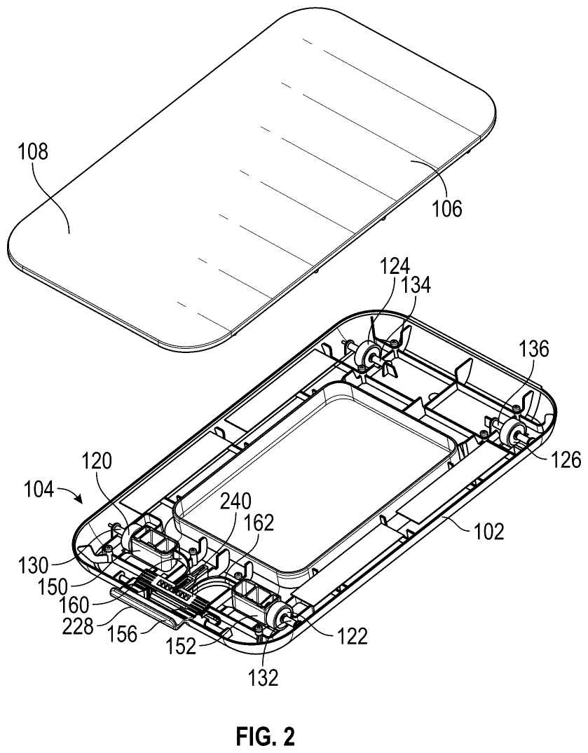

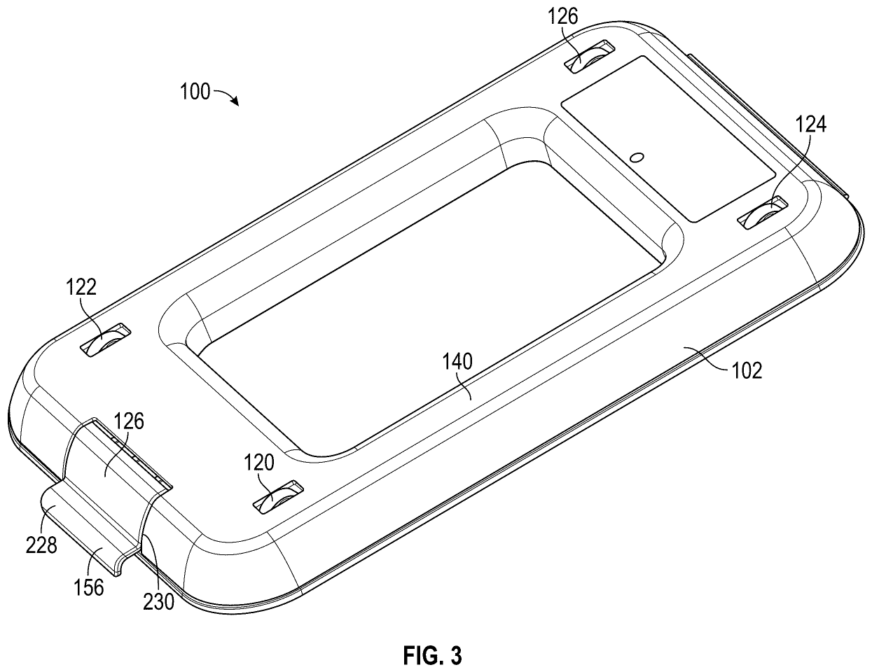

The base 102 rotatably supports at least one wheel, which allows the support 100 to move along a subjacent surface, such as a countertop typically found in a kitchen. In FIGS. 2 and 3, the at least one wheel includes first and second wheels 120 and 122 associated with the braking mechanism 104 at one end portion of the base 102 (hereafter also referred to a front wheels) and third and fourth wheels 124 and 126 at an opposite end portion of the base 102 (hereafter also referred to a rear wheels). The front wheels 120 and 122 are rotatably supported by first and second axles 130 and 132, respectively. The rear wheels 124 and 126 are rotatably supported by third and fourth axles 134 and 136, respectively. The axles are mounted to the base 102 in a known manner. The front and rear wheels at least partially extend from a bottom surface 140 of the base 102. In the depicted aspect, the front wheels 120 and 122 and the rear wheels 124 and 126 rotate about fixed axes defined by the respective axles. However, it should be appreciated that at least the rear wheels 124 and 126 may be configured as multi-directional wheels, for example, casters, and may be mounted to the base with or without the third and fourth axles 134 and 136.

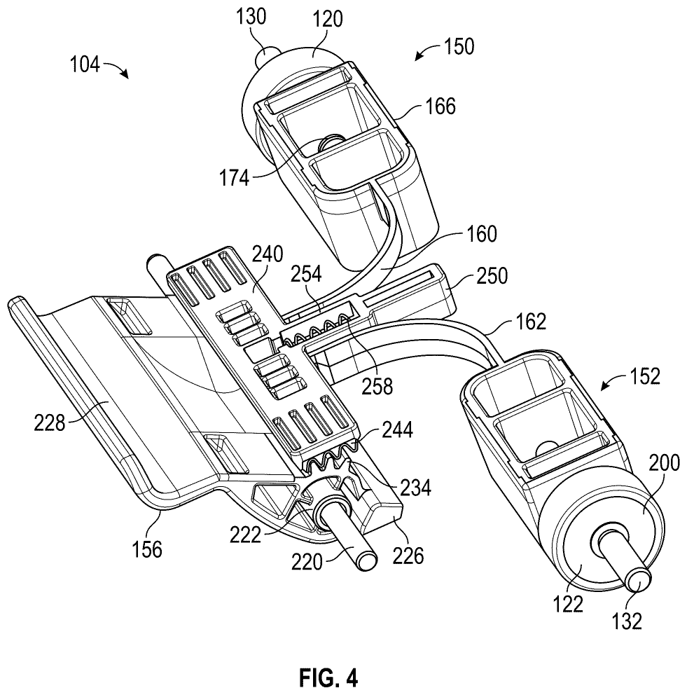

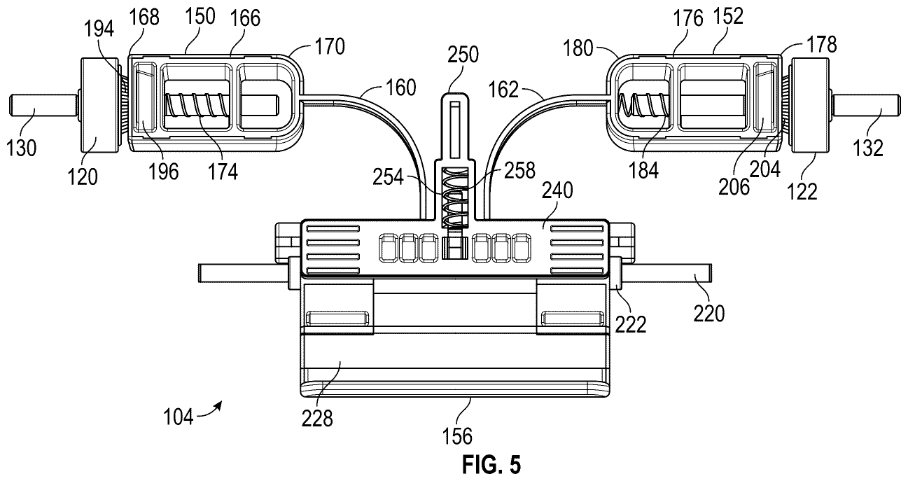

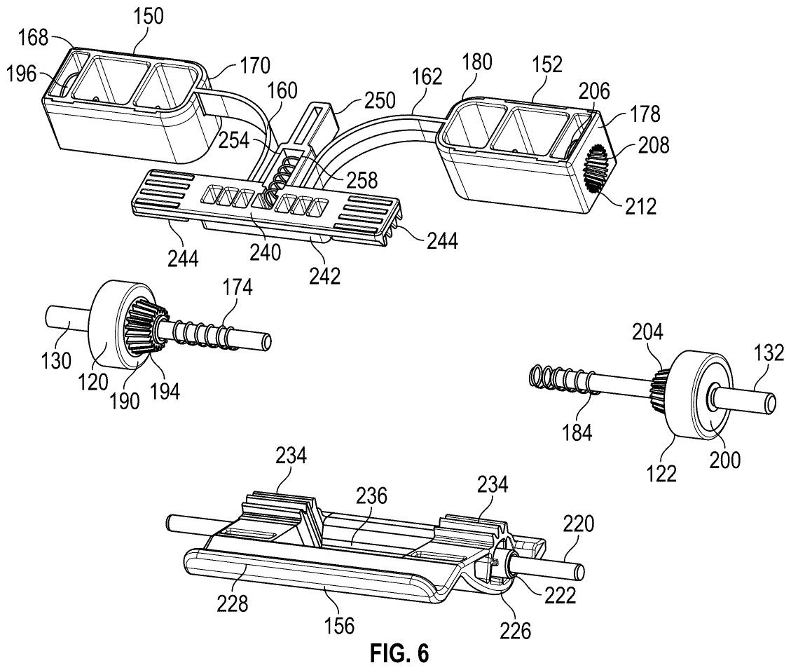

The braking mechanism 104 generally includes a brake member in selective engagement with at least one of the front wheels 120 and 122, an operating member, and a flexible connector connecting the brake member to the operating member. More particularly, and with reference to FIGS. 4, 5 and 6, the braking mechanism 104 includes first and second brake members 150 and 152 for the respective first and second wheels 120 and 122, an operating member 156, and first and second flexible connectors 160 and 162 connecting the respective first and second brake members 150 and 152 to the operating member 156.

The first brake member 150 includes a body 166 having a first end 168 and a second opposite end 170. The first axle 130 of the first wheel 120 is extended through the body 166 from the first end 168 toward the second end 170, which is secured to the first connector 160. A biasing member 174 secured by the body 166 is adapted to bias the first brake member 150 toward the first wheel 120. Similarly, the second brake member 152 includes a body 176 having a first end 178 and a second opposite end 180, which is secured to the second connector 162. The second axle 132 of the second wheel 122 is extended through the body 176 from the first end 178 toward the second end 180. A biasing member 184 secured by the body 176 is adapted to bias the second brake member 152 toward the second wheel 122. In the depicted aspect, the biasing member 174 is a spring mounted on part of the first axle 130 extended through the body 166, and the biasing member 184 is a spring mounted on part of the second axle 132 extended through the body 176.

The first wheel 120 includes a hub 190 mounted to and surrounding the first axle 130. According to the present disclosure, the hub 190 has a first engagement feature 194 of the brake mechanism 104 extended axially therefrom. The first end 168 of the first brake member 150 has a second engagement feature 196 of the brake mechanism 104 that is complementary with the first engagement feature. The first engagement feature 194 is a gear. The second engagement feature 196 is a structure provided at the first end that has an inner surface (not visible) defining a recess shaped to receive the gear. The inner surface has gear teeth for meshingly engaging the gear 194. In the depicted aspect, the gear 194 is a conical shaped gear and the inner surface is complementary shaped which allows for ease of engagement as the first brake member 150 is axially moved toward the first wheel 120.

Similar in construction, the second wheel includes a hub 200 mounted to and surrounding the second axle 132. The hub 200 has a first engagement feature 204 of the brake mechanism 104 extended axially therefrom, and the first end 178 of the second brake member 152 has a second engagement feature 206 of the brake mechanism 104 that is complementary with the first engagement feature. The first engagement feature 204 is a gear. The second engagement feature 206 is a structure provided at the first end that has an inner surface 208 defining a recess shaped to receive the gear. The inner surface 208 has gear teeth 212 for meshingly engaging the gear 204. It should be appreciated that the second engagement feature 196 of the first brake member 150 is similarly designed. In the depicted aspect, the gear 204 is a conical shaped gear and the inner surface is complementary shaped which allows for ease of engagement as the second brake member 152 is axially moved toward the first wheel 122.

The brake mechanism 104 is configured to convert rotational movement of the operating member 156 to translational movement of the first and second brake members 150 and 152. As shown in FIGS. 4-6, the operating member 156 is rotatably connected to the base 102 via a pin 220, which extends through a receiving part 222 on the operating member and is secured by the base. The operating member 156 includes a body 226 and a handle 228 extended from the body. In FIG. 3, the body 226 is received in a cutout 230 provided in the base 102 and is shaped to substantially conform to a shape of the base. The receiving part 222 is provided as part of the body. The body 226 includes gear teeth 234 on opposite sides of the body and a centrally located recessed area 236. The brake mechanism 104 further includes a linkage 240 coupled to the operating member 156. The linkage 240 is extended along a length of the body 226 and includes a lower part 242 seated in the recessed area 236 of the body 226. This centers the linkage 240 on the body 226 and allows the operating member 156 to rotate relative to the linkage. The linkage 240 includes gear teeth 244 complementary in shape to and meshingly engaged with the gear teeth 234 of the operating member 156. The linkage 240 further includes a stem 250 extended toward the first and second brake members 150 and 152. The stem 250 includes an elongated opening 254 for receiving a biasing member 258, such as a spring. However, alternative biasing members, such an elastomeric component sized to be received in the elongated opening 254, may be used. The biasing member 258 biases the linkage 240 toward the first and second brake members 150 and 152.

The first and second connectors 160 and 162 are secured to the linkage 240 and connect the linkage to the first and second brake members 150 and 152. In the depicted aspect, the first and second connectors 160 and 162 are flexible bands that curl outwardly from the linkage 240 to the first and second brake members.

The operating member 156 is movable from a first position where each brake member 150, 152 is engaged with the respective wheel 120 and 122 to a second position where each brake member is disengaged from the respective wheel. The first and second connectors 160 and 162 move both in a first direction (i.e., along axes defined by the first and second axles 130 and 132) and a second direction transverse to the first direction as the operating member is moved between the first position and the second position. Particularly, the operating member 156 is rotatable about an axis defined by the pin 220. As a user rotates the operating member 156 via the handle 228, the gear teeth 234 of the operating member 156 mesh with the gear teeth on the linkage 240. This interface turns rotational movement of the operating member 156 into a translating motion on the linkage 240. The linkage 240 is attached to each body 166 and 176 of the first and second brake members 150 and 152 via the respective first and second flexible connectors 160 and 162. This allows the translational movement of the linkage 240 to pull the first and second brake members 150 and 152 away from the first and second wheels 120 and 122. The wheel hubs 190 and 200 of the first and second wheels 120 and 122 have the respective conical gears 194 and 204 and the bodies 166 and 176 of the first and second brake members 150 and 152 have the correspondingly shaped gear teeth molded in (only gear teeth 212 of body 176 is shown), so in a default, engaged state the conical teeth on the brake members 150 and 152 mesh with the conical gears 194 and 204 on the wheel preventing wheel rotation. When the operating member 156 is depressed or rotated, the linkage 240 translates moving the first and second brake members 150 and 152 to a disengaged state and allows for free rotation of the wheels. The conical gears teeth on the front wheels means the travel necessary to disengage the first and second brake members 150 and 152 is minimal. The biasing members 174 and 184 on the first and second brake members 150 and 152 and the biasing member 258 on the linkage 240 pull the first and second brake members 150 and 152 back to the engaged state when the operating member 156 is released.

According to the present disclosure, the brake mechanism 104 comprises the operating member 156 having a first part (i.e., the linkage 240) movable in a first direction. The first and second brake members 150 and 152 are movable in a second direction between an engaged state for braking the respective first and second wheels 120 and 122 of the support 100 and a disengaged state. The second direction is transverse to the first direction. The first and second flexible connectors 160 and 162 connect the operating member 156 to the respective first and second brake members 150 and 152. Movement of the first part of the operating member 156 in the first direction moves the first and second brake members in the second direction between the engaged state and the disengaged state.

The first part is the linkage 240 having gear teeth 244 and the operating member includes a second part (i.e., the body 226) rotatable about an axis. The second part includes gear teeth 234 that meshingly engage the gear teeth 244, wherein rotation of the second part moves the first part in the first direction. It should be appreciated that alternative configurations of the operating member are contemplated. For example, the operating member can be a push button provided on the base 102 or cover 106. The push button can have a second part with gear teeth that directly or indirectly (i.e., via a pinion gear) meshing engage the gear teeth 244 of the linkage 240. With this alternative arrangement of the operating member, depression of the second part of the push button in a second direction moves the first part (i.e., the linkage 240) in the first direction.

According to the present disclosure, the support 100 enables the countertop appliance to be stored on the countertop proximate a back edge of the countertop and at least partially under a cabinet so that the appliance is readily accessible when it is desired to use the appliance. When the support 100 is a stand-alone support, the cover 106 is located a small distance above an upper surface of the countertop to minimize the potential that appliances placed on the support 100 will not fit under the cabinet.

It will be appreciated that various of the above-disclosed embodiments and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A support for an appliance comprising:
a base rotatably supporting a wheel; and
a braking mechanism secured by the base, the braking mechanism including a brake member in selective engagement with the wheel, an operating member, and a flexible connector connecting the brake member to the operating member,
wherein the operating member is movable from a first position where the brake member is engaged with the wheel to a second position where the brake member is disengaged from the wheel,
wherein the connector moves both in a first direction and a second direction transverse to the first direction as the operating member is moved between the first position and the second position.

2. The support of claim 1, wherein the wheel includes a hub surrounding an axle, the hub having a first engagement feature, and the brake member has a second engagement feature complementary with the first engagement feature.

3. The support of claim 2, wherein the first engagement feature is a gear and the second engagement feature is defined by an inner surface having a recess shaped to receive the gear, the inner surface including gear teeth for meshingly engaging the gear.

4. The support of claim 3, wherein the gear is a conical shaped gear.

5. The support of claim 3, wherein the brake member includes a body having a first end with the recess and a second opposite end secured to the connector, the axle of the wheel extended through the body from the first end toward the second end.

6. The support of claim 1, wherein the brake member includes a biasing member adapted to bias the brake member toward the wheel.

7. The support of claim 1, wherein the connector is a flexible band.

8. The support of claim 1, wherein the operating member is rotatably connected to the base, and the brake mechanism is configured to convert rotational movement of the operating member to translational movement of the brake member.

9. The support of claim 8, wherein the brake mechanism includes a linkage coupled to the operating member, and the connector is secured to the linkage.

10. The support of claim 9, wherein the linkage includes first teeth and the operating member including corresponding second teeth that meshingly engage the first teeth on the linkage.

11. The support of claim 1, wherein the base is one of separate from the appliance and provided as part of the appliance.

12. A braking mechanism for a wheeled support for an appliance, the brake mechanism comprising:
an operating member with a first part movable in a first direction;
first and second brake members movable in a second direction between an engaged state for braking respective first and second wheels of the support and a disengaged state, the second direction transverse to the first direction; and
first and second flexible connectors connecting the operating member to the respective first and second brake members, wherein movement of the first part of the operating member in the first direction moves the first and second brake members in the second direction between the engaged state and a disengaged state.

13. The braking mechanism of claim 12, wherein the first part is a linkage having first teeth, the first and second connectors secured to the linkage.

14. The braking mechanism of claim 13, wherein the operating member includes a second part rotatable about an axis, the second part includes second teeth that meshingly engage the first teeth, wherein rotation of the second part moves the first part in the first direction.

15. The braking mechanism of claim 12, including first and second biasing members adapted to bias the respective first and second brake member toward the respective first and second wheels.

16. The braking mechanism of claim 12, including a gear provided on each of the first and second wheels, and each first and second brake member includes an inner surface defining a recess shaped to receive the gear, each inner surface including gear teeth which meshingly engage the gear.

17. The braking mechanism of claim 16, wherein each gear on each of the first and second wheels is a conical shaped gear.
